(19) United States
(12) Patent Application Publication
(10) Pub. No.: US 2017/0097530 A1
(43) Pub. Date: Apr. 6, 2017

(54) PHOTO-CONVERSION MEANS FOR LIQUID CRYSTAL DISPLAYS

(71) Applicant: AU Optronics Corporation, HSIN-CHU (TW)

(72) Inventors: Tzu-Yi TSAO, HSIN-CHU (TW); Cheng-Yeh TSAI, HSIN-CHU (TW); Fang-Cheng YU, HSIN-CHU (TW); Yi-Fen LAN, HSIN-CHU (TW); Yi-Ting CHEN, HSIN-CHU (TW); Pu-Jung HUANG, HSIN-CHU (TW); Szu-Yu LIN, HSIN-CHU (TW)

(21) Appl. No.: 14/872,288

(22) Filed: Oct. 1, 2015

(51) Int. Cl. G02F 1/133; G02F 1/1335

(52) U.S. Cl. CPC G02F 1/13306; G02F 1/133509; G02F 2001/13324

(57) ABSTRACT

A blue phase liquid crystal display having a first substrate, a second substrate and a liquid crystal layer disposed therebetween and a photo-conversion means disposed between the second substrate and the liquid crystal layer is provided. The photo-conversion means is for transferring a light of a predetermined wave length from a predetermined first electromagnetic radiation region to a predetermined second electromagnetic radiation region; the predetermined first electromagnetic radiation region being a visible wavelength region, and the predetermined second electromagnetic radiation region being an invisible wavelength region, thereby decreasing light leakage for generating a darker dark state; and wherein the photo-conversion means transfers the wavelength of ambient light before ambient light reflected from the blue phase liquid crystal to the visible region of 470 to 510 nanometers to avoid a shift of the wavelength into the visible region of 470 to 510 nanometers generated by the addition of a chiral dopant.

### TECHNICAL FIELD

The present invention relates to liquid crystal displays, and more particularly to blue phase and cholesteric liquid crystal displays.

### BACKGROUND OF THE INVENTION

The “blue phase” is a liquid crystal phase between the chiral nematic (cholesteric) and the isotropic phases, existing only in a narrow temperature range (2-3° C.), but having an extremely fast switching time.

The blue phase liquid crystal layer typically includes adding chiral dopants and/or monomers for increasing the temperature range by inducing the blue phase liquid crystal molecules to form double twist cylinders which are more stable and thus less susceptible to temperature variation.

The lattice period of the blue phase liquid crystals determines which wavelength of incident light will be reflected, and accordingly, selective Bragg reflection is generated based on the wavelength of the incident light. In other words, the blue phase liquid crystal molecules have a specific reflective band due to their material characteristics. The reflective band of undoped blue phase liquid crystal molecules falls in the visible light spectral range; however, there is a light leakage problem in a dark state of the liquid crystal display.

High concentrations of chiral dopants are typically added to the blue phase liquid crystal layer in a conventional blue phase liquid crystal display device since the greater lattice stability will reduce light leakage arising from differential reflection from lattice anomalies. However, high concentration of chiral dopants requires a higher operating voltage of the display, because the increased stability makes the liquid crystal molecules more difficult to turn.

U.S. Pat. No. 8,947,618 discloses a blue phase liquid crystal display that addresses the light leakage problem by avoiding light leakage through use of a specially designed backlight, thereby maintaining a high contrast ratio. P.R.C. Pat. No. CN100529804C discloses an absorption film that absorbs light of 470 nm to 510 nm wavelength. P.R.C. Pat. No. CN102654716B discloses a communications system that transforms wavelengths of light radiation using quantum entanglement. P.R.C. Pat. No. CN101188255A discloses a solar cell having a layer to transfer light from the Sun into red light.

Cholesteric Liquid Crystals (CLCs) are a naturally stable helical structure that retains an image without an applied voltage; the low power consumption makes them ideal for hand-held devices. Used in reflective mode displays further dispenses with a backlight, thereby reducing power consumption even further. In response to different electric fields, a cholesteric liquid crystal display can have its helical axis perpendicular to the substrate, and as such, the cholesteric liquid crystal is in a planar state, which naturally reflects light; and when the helical axis is not perpendicular to the substrate, it is in a focal conic state with no Bragg reflection. Switching between the planar and the focal states generates a bistable cholesteric display that is ideal for electronic readers and advertising displays. For CLCs, light is respectively reflected under the planar state and scattered under the focal conic state. The ratio of these two states determines the reflective intensity which produces gray scale. However, the transition between the two states may produce undesirable color shift. Color shift of the reflection band is therefore an inherent disadvantage of CLCs.

### SUMMARY

The present invention relates to a blue phase liquid crystal display, having a first substrate, a second substrate and a liquid crystal layer disposed therebetween, a photo-conversion means disposed between the second substrate and the liquid crystal layer, for transferring light of a predetermined wave length from a predetermined first electromagnetic radiation region to a predetermined second electromagnetic radiation region; the predetermined first electromagnetic radiation region being a visible wavelength region, and the predetermined second electromagnetic radiation region being an invisible wavelength region, thereby decreasing light leakage for generating a darker dark state and improving the contrast. The liquid crystal display further comprises a filter layer for blocking the predetermined first electromagnetic radiation region, and the present invention also relates to a cholesteric liquid crystal display, a predetermined undesired wavelength of light that is reflected by the cholesteric liquid crystal layer and the photo-conversion means transfers that light to a predetermined desired wavelength of light, thereby avoiding undesirable color shift.

### BRIEF DESCRIPTION OF THE DRAWINGS

The disclosure can be more fully understood by reading the following detailed description of the embodiments, with reference to the accompanying drawings as follows:

FIG. 1 is a graph of the reflective light of a chiral-doped blue phase liquid crystal layer (reflective luminance) as a function of the wavelength of the reflected light;

FIG. 2A shows the mechanism of the one-photon energy transition process of the first embodiment;

FIG. 2B is a graph showing normalized intensity of light as a function of the wavelength of incident light and radial light;

FIG. 3A shows the mechanism of the two-photon energy transition process of the first embodiment;

FIG. 3B is a graph showing normalized intensity of light versus wavelengths of the incident light and radial light;

FIG. 4 is a schematic of a reflective-type blue phase liquid crystal display according to an embodiment of the present invention;

FIG. 5 is a schematic diagram of a reflective-type blue phase liquid crystal display according to an embodiment of the present invention;

FIG. 6 is a schematic of a reflective-type blue phase liquid crystal display according to an embodiment of the present invention;

FIG. 7 shows a schematic of a transflective-type blue phase liquid crystal display according to an embodiment of the present invention;

FIG. 8 shows a schematic of a transflective-type blue phase liquid crystal display according to an embodiment of the present invention;

FIG. 9 shows a schematic of a transflective-type blue phase liquid crystal display according to an embodiment of the present invention;

FIG. 10 shows a schematic of a transflective-type blue phase liquid crystal display according to an embodiment of the present invention;

FIG. 11 shows a schematic of a transmissive-type blue phase liquid crystal display according to an embodiment of the present invention;

FIG. 12 shows a schematic of a transmissive-type blue phase liquid crystal display according to an embodiment of the present invention;

FIG. 13 shows a schematic of a transmissive-type blue phase liquid crystal display according to an embodiment of the present invention;

FIG. 14 shows a schematic of a transmissive-type blue phase liquid crystal display according to an embodiment of the present invention;

FIG. 15 shows a schematic of a cholesteric liquid crystal display according to an embodiment of the present invention; and

FIG. 16 shows a schematic of a cholesteric liquid crystal display according to an embodiment of the present invention.

### SPECIFICATION

The present invention relates to improving the image in a liquid crystal display, and more particularly to a photo-conversion means for improving the dark state and thereby the contrast is increased.

In the following description, several specific details are presented to provide a thorough understanding of the embodiments of the present invention. One skilled in the relevant art will recognize, however, that the present invention can be practiced without one or more of the specific details, or in combination with or with other components.

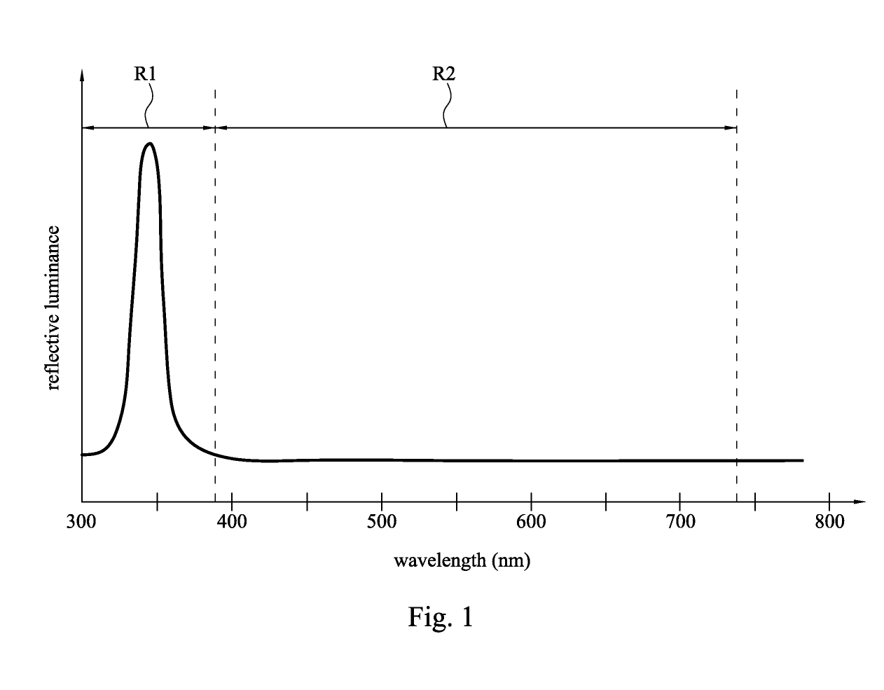

The present embodiment is a blue phase liquid crystal display, wherein the blue phase liquid crystal layer comprises blue phase liquid crystal molecules and chiral dopants. The chiral dopants are used to form double twist cylinders of the blue phase liquid crystal. The lattice period of the blue phase liquid crystals determines which wavelength of incident light will be reflected, and accordingly, selective Bragg reflection is generated based on the wavelength of the incident light. The reflective band of undoped blue phase liquid crystal layer falls within a visible light spectral range, generating undesirable light leakage in a dark state thereby degrading the display's contrast. The blue phase liquid crystal layer has typically included the addition of chiral dopants and/or monomers for increasing the temperature range by inducing the blue phase liquid crystal molecules to form double twist cylinders which are more stable and thus less susceptible to temperature variation. FIG. 1 is a graph of the reflective light of a chiral-doped blue phase liquid crystal layer (reflective luminance) as a function of the wavelength of the reflected light. The greatest reflective luminance falls in the ultraviolet light range (R1) and outside the visible light range (R2). That is, the addition of a chiral dopant in the blue phase liquid crystal molecules causes a light shift to the ultraviolet light range R1 thereby reducing light leakage in the dark state.

The higher concentration of the chiral dopants, however, requires a higher operating voltage because of the aforementioned stability of the doped blue phase liquid crystal layer. In order to operate the display at a lower voltage, lower concentration of chiral dopant are therefore desirable, so the present embodiment discloses a means to reduce light leakage in the dark state in a lower-concentration chiral dopant blue phase liquid crystal display, thereby achieving such a dark state but at lower operating voltages.

The preferred embodiment of the present invention is a thin film layer disposed in the blue phase liquid crystal display, and more particularly a photo-conversion layer which transfers light of a predetermined wave length from a predetermined first light region to a second predetermined light region in a blue phase liquid crystal display wherein the photo-conversion layer transfers visible wavelength light to invisible wavelength light, thereby decreasing light leakage for producing a darker dark state.

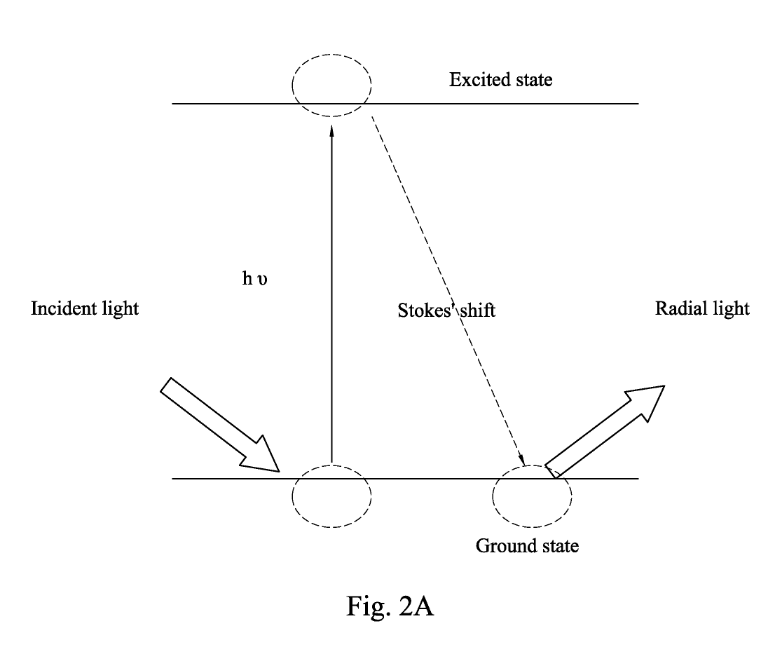

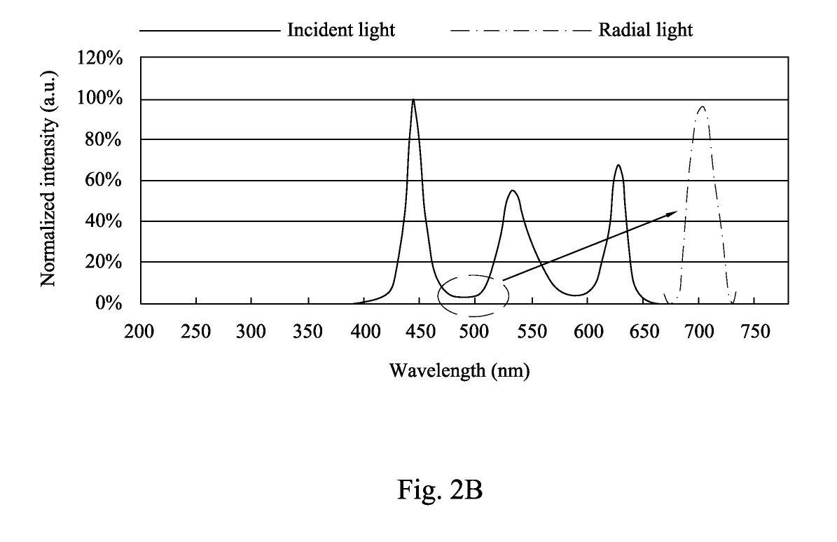

In this preferred embodiment, the photo-conversion means transfers electromagnetic radiation in a so-called one-photon energy transition process from a wavelength region of 470 to 510 nanometers to a wavelength region of greater than 680 nanometers. FIG. 2A shows the mechanism of the one-photon energy transition process. For incident light with wavelength of 470 to 510 nanometers, a photon having energy hv (where h is a constant factor and v is the frequency) is excited from a Ground state to an Excited state, so light with wavelength of greater than 680 nanometers is obtained; this is known in the art as a “Stokes shift”. FIG. 2B is a graph showing normalized intensity of light as a function of the wavelength of incident light and radial light. Incident light is represented by solid line, and radial light is represented by dot-dashed line. Long wavelength region of greater than 680 nanometers is transformed from the incident light with a wavelength region of 470 to 510 nanometers in a one-photon energy transition process.

The long wavelengths mentioned above are in the invisible light spectrum and therefore does not generate light leakage in the dark state of the blue phase liquid crystal display, and only the radial light enters into the blue phase liquid crystal layer.

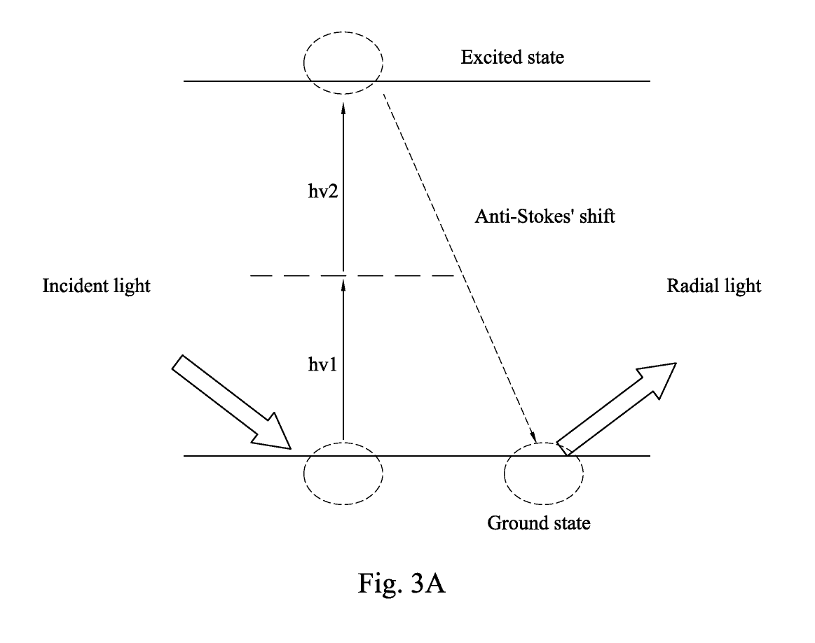

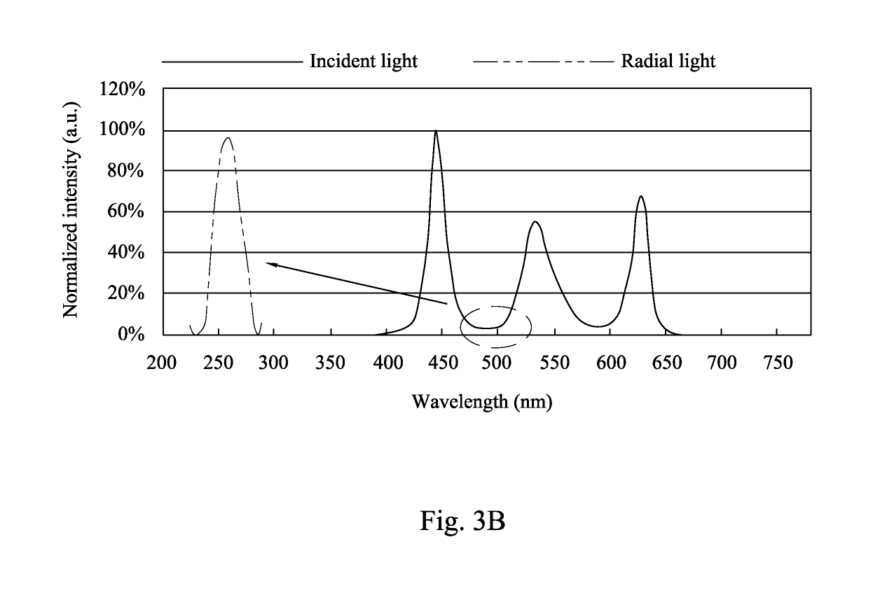

The preferred embodiment of the present invention also includes a photo-conversion means transferring electromagnetic radiation in a so-called two-photon energy transition process from a wavelength region of 470 to 510 nanometers to a wavelength region of smaller than 380 nanometers. FIG. 3A shows the mechanism of the two-photon energy transition process wherein an incident light with wavelength of 470 to 510 nanometers corresponding to a photon of energy hv₁ and a subsequent photon of energy hv₂ is absorbed, causing the atom to transition from a Ground state to an Excited state, the “Anti-Stokes' shift”, causing a shift in the wavelength region of incident light. As a result, radial light with wavelength of smaller than 380 nanometers is obtained. FIG. 3B is a graph showing normalized intensity of light versus wavelengths of the incident light and radial light. Incident light is represented by solid line, and radial light is represented by dashed line. The light is transformed from a wavelength region of 470 to 510 nanometers to a relatively shorter wavelength region (smaller than 380 nanometers) in a two-photon energy transition process, thereby decreasing light leakage in the dark state of the blue phase liquid crystal display.

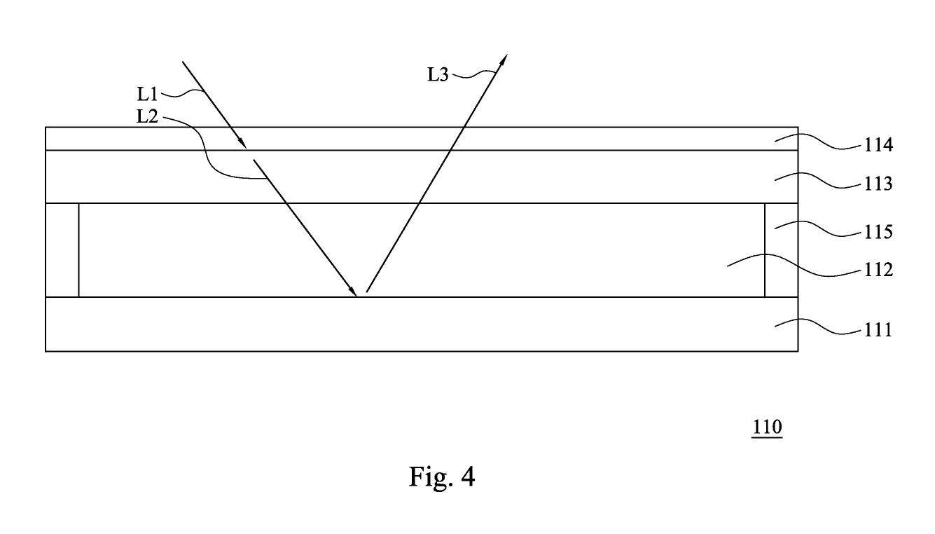

FIG. 4 is a schematic of a reflective-type blue phase liquid crystal display according to an embodiment of the present invention. Reflective-type blue phase liquid crystal display 110 includes first substrate 111, blue phase liquid crystal layer 112, second substrate 113, photo-conversion means 114 and sealant 115. The second substrate 113 is disposed between the blue phase liquid crystal layer 112 and the photo-conversion means 114. Those skilled in the art will recognize that in the present invention, the first substrate 111 also may include in-plane switch (IPS) pixel arrays or fringe fields switching (FFS) pixel arrays. The pixel array may include scan lines, data lines, thin film transistors and pixel electrodes electrically connected correspondingly. The first substrate 111 may further include a reflective layer or the pixel electrode of the pixel array is reflective for reflect light to perform a reflective-type images process. The blue phase liquid crystal layer 112 may include blue phase liquid crystal molecules and chiral dopants. Concentration of chiral dopants is 0.01% to 10.0% wt %. The operating voltage thereof is 10V to 100V. The second substrate 113 may include color filter layers.

The structure of the photo-conversion means 114 may be at least one thin film, at least one nano thin film containing quantum dot, wells, or combinations thereof. The material of the photo-conversion means 114 may include an organic material, metal, a semiconductor material or combinations thereof. For example, the material of the photo-conversion means 114 may comprise 9-Hydroxyphenalen-1-one Ligand and the chemical structure of which is as below, where M is Nd(III), Er(III) or Yb(III), and n is 3 or 4.

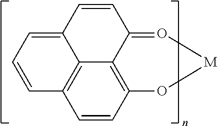

The photo-conversion means 114 may be deposited on and contact the second substrate 113, or attached to the second substrate 113, or formed by other appropriate manufacturing methods.

As shown in FIG. 4, incident light L1, which may be ambient light or sunlight for example, enters the photo-conversion means 114. The incident light L1 is with a predetermined first electromagnetic radiation region comprising a visible wavelength region. The visible wavelength region of the predetermined first electromagnetic radiation region is 470 to 510 nanometers, for example. The photo-conversion means 114 transfers the incident light L1 into a transferred light L2 passing through the blue phase liquid crystal layer 112 and then reflected by the reflective pixel electrode of the first substrate 111 to form image light L3 to display images.

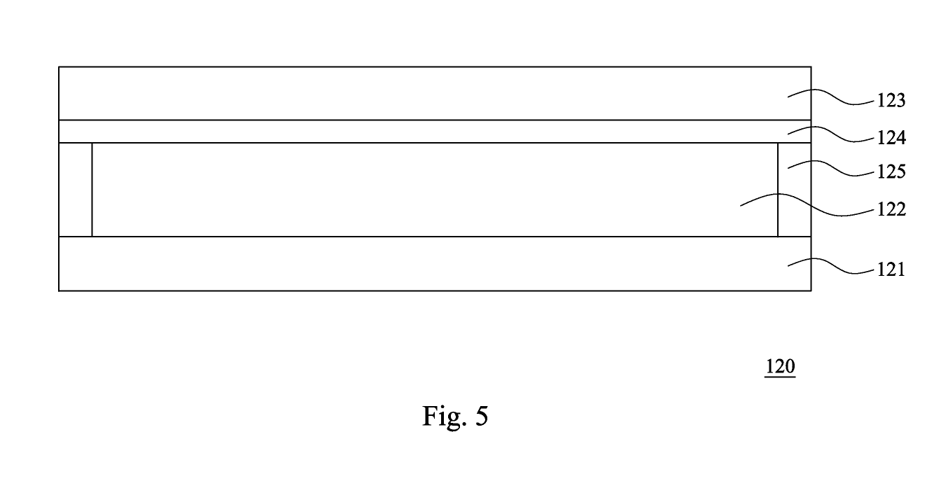

FIG. 5 is a schematic diagram of a reflective-type blue phase liquid crystal display according to an embodiment of the present invention. Reflective-type blue phase liquid crystal display 120 includes first substrate 121, blue phase liquid crystal layer 122, second substrate 123, photo-conversion means 124 and sealant 125. Note that in this embodiment, the photo-conversion means 124 is disposed between the second substrate 123 and the blue phase liquid crystal layer 122. The operation is as described above.

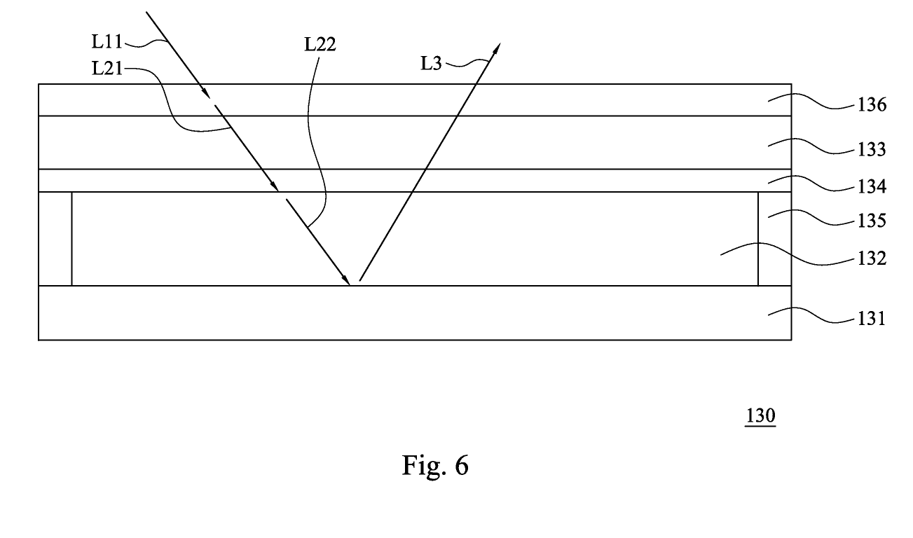

FIG. 6 is a schematic of a reflective-type blue phase liquid crystal display according to an embodiment of the present invention. A reflective-type blue phase liquid crystal display 130 includes first substrate 131, blue phase liquid crystal layer 132, second substrate 133, photo-conversion means 134, sealant 135 and filter 136. The reflective-type blue phase liquid crystal display 130 further includes filter 136 adjacent to the second substrate 133. The filter 136 is a means for blocking the predetermined first electromagnetic radiation, thereby decreasing light leakage for generating a darker dark state. The filter 136 absorbs or reflects light with wavelength of about 470 to 510 nanometers and then the passed light is with wavelength of other than about 470 to 510 nanometers. The filter 136 may be composed of material including dye or pigment. For example, the material of the filters comprises Anthraquinone dye, perinone dye, monoazo dye, disazo dyes, Methine dye.

In the present example, the second substrate 133 is disposed between the filter 136 and the photo-conversion means 134, but not limited thereto. The filter 136 and the photo-conversion means 134 may be located at the same side of the second substrate 133 and are adjacent to the blue phase liquid crystal layer 122 or are separated by the second substrate 133.

As shown in FIG. 6, incident light L11, which may be ambient light or sunlight for example, enters the filter 136. The incident light L11 is with a predetermined first electromagnetic radiation region comprising a visible wavelength region. The visible wavelength region of the predetermined first electromagnetic radiation region is 470 to 510 nanometers, for example. The filter 136 absorbs or reflects visible wavelength region of the incident light L11, and therefore a first transferred light L21 is output from the filter 136. If the filter 136 does not completely and totally absorbs or reflects visible wavelength region of the incident light L11, the first transferred light L21 is still with a visible wavelength region which may be different from the visible wavelength region of the incident light L11. The first transferred light L21 then enters the photo-conversion means 134 and the photo-conversion means 134 transfers the first transferred light L21 into a second transferred light L22 to pass through the blue phase liquid crystal layer 132 and then reflected by the reflective pixel electrode of the first substrate 131 to form image light L3 to display images. The second transferred light L22 is with a predetermined second electromagnetic radiation region comprising an invisible wavelength region. The predetermined second electromagnetic radiation region comprises an exclusive wavelength region other than 380 to 680 nanometers. The exclusive wavelength region of the predetermined second electromagnetic radiation region is greater than 680 nanometers or smaller than 380 nanometers. Wavelength transformation mechanism may refer to the above mentioned one-photon energy transition process or two-photon energy transition process. Because of the filter 136, specific light with the specific wavelength of about 470 to 510 nanometers can be accurately and successfully removed. As a result, the second transferred light L22 which passes through the blue phase liquid crystal layer 132 is of an invisible wavelength region, thereby decreasing light leakage for generating a darker dark state.

The filter of the present embodiment may be utilized in transflective-type blue phase liquid crystal displays and transmissive-type blue phase liquid crystal displays. Further, the filter may be substituted for the photo-conversion means, therefore photo-conversion means may be omitted. Materials and relative positions to other elements illustrated above are solely for reference, and do not limit the scope of this invention.

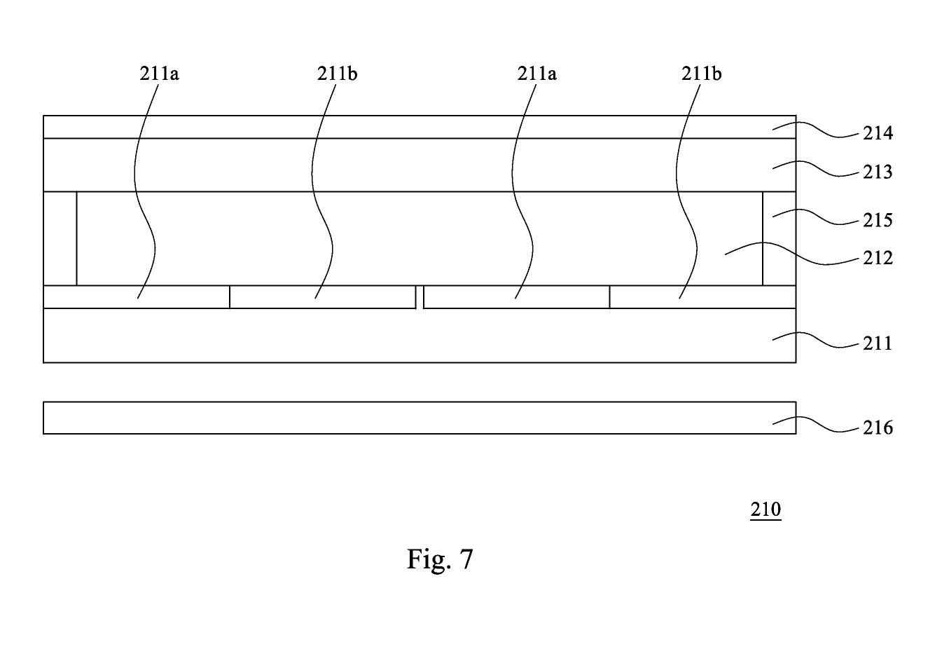

FIG. 7 shows a schematic of a transflective-type blue phase liquid crystal display according to an embodiment of the present invention. Transflective-type blue phase liquid crystal display 210 includes first substrate 211, blue phase liquid crystal layer 212, second substrate 213, photo-conversion means 214, sealant 215 and backlight module 216. The elements and function of the present embodiment are similar to that of the previous embodiment. Detail illustrations are omitted. However, in the present embodiment, the transflective-type blue phase liquid crystal display 210 further includes backlight module 216 and the first substrate 211 includes transmissive electrodes 211a and reflective electrodes 211b disposed within the transmissive area and reflective area, respectively. The backlight module 216 may emit white light but not limited thereto. Alternatively, the backlight module 216 may include light emitting diodes (LEDs) array to emit red, green and blue light driven by a field sequential technology.

In the transflective-type blue phase liquid crystal display, image light L3 corresponding to the transmissive area is generated and processed from the transmissive electrodes and the light of the backlight module, while image light L3 corresponding to the reflective area is generated and processed from the reflective electrodes and the light of the ambiance or sunlight.

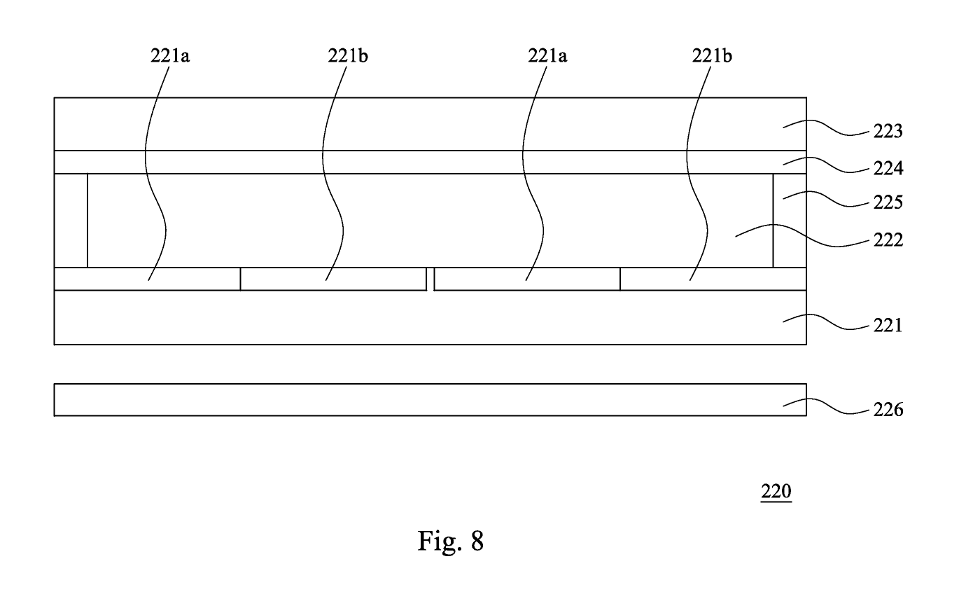

FIG. 8 shows a schematic of a transflective-type blue phase liquid crystal display according to an embodiment of the present invention. Transflective-type blue phase liquid crystal display 220 includes first substrate 221, blue phase liquid crystal layer 222, second substrate 223, photo-conversion means 224, sealant 225 and backlight module 226. The elements and function of the present embodiment are similar to that of the previous embodiment. Detail illustrations are omitted. However, in the present embodiment, the transflective-type blue phase liquid crystal display 220 further includes backlight module 226 and the first substrate 221 includes transmissive electrodes 221a and reflective electrodes 221b disposed within the transmissive area and reflective area, respectively.

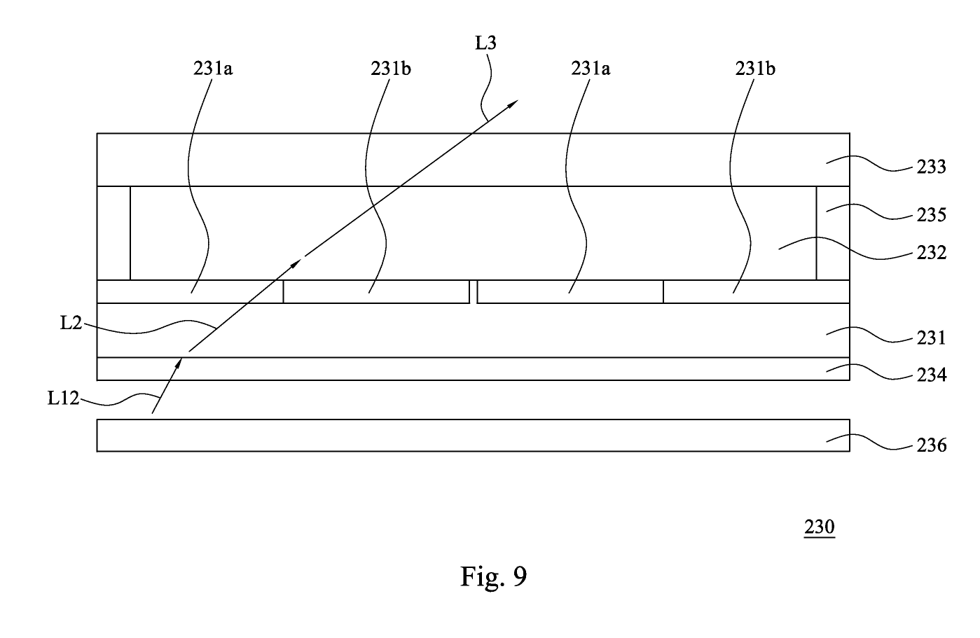

FIG. 9 shows a schematic of a transflective-type blue phase liquid crystal display according to an embodiment of the present invention. Transflective-type blue phase liquid crystal display 230 includes first substrate 231, blue phase liquid crystal layer 232, second substrate 233, photo-conversion means 234, sealant 235 and backlight module 236. The first substrate 231 includes transmissive electrodes 231a and reflective electrodes 231b disposed within the transmissive area and reflective area, respectively. The elements and function of the present embodiment are similar to that of the above mentioned embodiments of the present invention. Detail illustrations are omitted. However, the photo-conversion means 234 is disposed between the first substrate 231 and the backlight module 236.

As shown in FIG. 9, backlight L12 provided by the backlight module 236 enters the photo-conversion means 234. The backlight L12 is with a predetermined first electromagnetic radiation region comprising a visible wavelength region. The visible wavelength region of the predetermined first electromagnetic radiation region is 470 to 510 nanometers, for example. The photo-conversion means 234 transfers the backlight L12 into a transferred light L2 and then the transferred light L2 passes through the blue phase liquid crystal layer 232 to form image light L3, which is corresponding to the transmissive area and transmissive electrodes 231a, to display images. The transferred light L2 is with a predetermined second electromagnetic radiation region comprising an invisible wavelength region. The predetermined second electromagnetic radiation region comprises an exclusive wavelength region other than 380 to 680 nanometers. The exclusive wavelength region of the predetermined second electromagnetic radiation region is greater than 680 nanometers or smaller than 380 nanometers. Wavelength transformation mechanism may refer to the above mentioned one-photon energy transition process or two-photon energy transition process. Transferred light L2 which passes through the blue phase liquid crystal layer 232, is of an invisible wavelength region, thereby decreasing light leakage for generating a darker dark state.

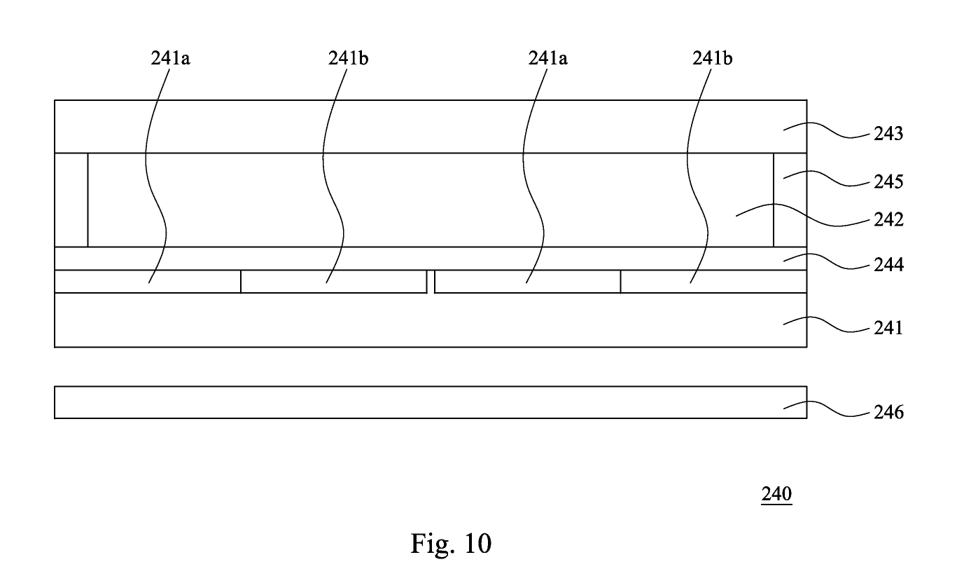

FIG. 10 shows a schematic of a transflective-type blue phase liquid crystal display according to an embodiment of the present invention. Transflective-type blue phase liquid crystal display 240 includes first substrate 241, blue phase liquid crystal layer 242, second substrate 243, photo-conversion means 244, sealant 245 and backlight module 246. The first substrate 241 includes transmissive electrodes 241a and reflective electrodes 241b disposed within the transmissive area and reflective area, respectively. The elements and function of the present embodiment are similar to that of the previous embodiment of the present invention. Detail illustrations are omitted. However, the photo-conversion means 244 is disposed adjacent to the blue phase liquid crystal layer 242.

As shown in FIG. 10, the photo-conversion means 244 is disposed between the blue phase liquid crystal layer 242 and the electrodes 241a, 241b. The blue phase liquid crystal layer 242 is immediately above the photo-conversion means 244. In the structural design, transferred light L2 output from the photo-conversion means 244 enters the blue phase liquid crystal layer 242 with passing few or none of other films located between the blue phase liquid crystal layer 242 and the photo-conversion means 244. Therefore, light usage can be greatly improved.

Other alternatives may be applied in the present embodiment. For example, the electrodes 241a, 241b may be disposed between the blue phase liquid crystal layer 242 and the photo-conversion means 244. The photo-conversion means 244 can be formed by thin film deposition process and can be a sub-element or a portion of the thin film transistor array. The photo-conversion means 244 may be gate insulator of the thin film transistor of the thin film transistor array, or any passivation layer or insulating layer formed within the thin film transistor array, for instance. Manufacturing cost and steps can be easily controlled accordingly.

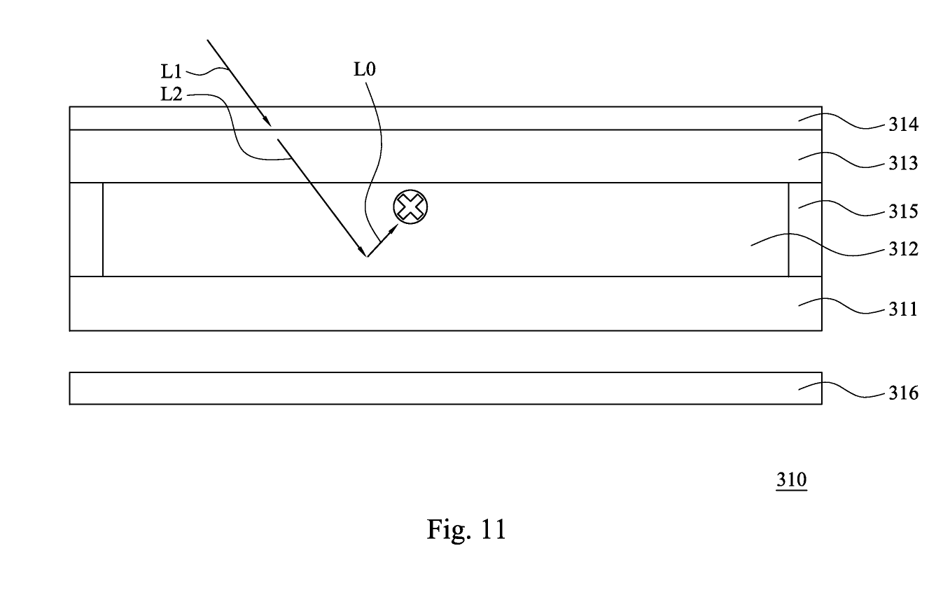

FIG. 11 shows a schematic of a transmissive-type blue phase liquid crystal display according to an embodiment of the present invention. Transmissive-type blue phase liquid crystal display 310 includes first substrate 311, blue phase liquid crystal layer 312, second substrate 313, photo-conversion means 314 sealant 315 and backlight module 316. The second substrate 313 is disposed between the blue phase liquid crystal layer 312 and the photo-conversion means 314. The first substrate 311 may include in-plane switching (IPS) pixel array or fringe fields witching (FFS) pixel array. Pixel array may include scan lines, data lines, thin film transistors and pixel electrodes electrically connected correspondingly. The pixel electrode of the pixel array is transparent and transmissive. The blue phase liquid crystal layer 312 may include blue phase liquid crystal molecular and chiral dopants. The second substrate 313 may include color filter layers.

The structure of the photo-conversion means 314 may be at least one thin film, at least one nano thin film containing quantum dot, wells, or combinations thereof. The material of the photo-conversion means 314 may include an organic material, metal, a semiconductor material or the combinations thereof. The photo-conversion means 314 may be deposited on and contact the second substrate 313, or attached to the second substrate 313, or other suitable manufacturing methods.

As shown in FIG. 11, incident light L1, which may be ambient light or sunlight for example, enters the photo-conversion means 314. The incident light L1 is with a predetermined first electromagnetic radiation region comprising a visible wavelength region. The visible wavelength region of the predetermined first electromagnetic radiation region is 470 to 510 nanometers, for example. The photo-conversion means 314 transfers the incident light L1 into a transferred light L2 and the transferred light L2 passing into the blue phase liquid crystal layer 312. The transferred light L2 is with a predetermined second electromagnetic radiation region comprising an invisible wavelength region. The predetermined second electromagnetic radiation region comprises an exclusive wavelength region other than 380 to 680 nanometers. The exclusive wavelength region of the predetermined second electromagnetic radiation region is greater than 680 nanometers or smaller than 380 nanometers. Wavelength transformation mechanism may refer to the above mentioned one-photon energy transition process or two-photon energy transition process.

Because the transferred light L2 is with a predetermined second electromagnetic radiation region comprising an invisible wavelength region, even when it is reflected by the blue phase liquid crystal layer 312 and transferred into reflected or diffraction light L0, light leakage in the dark state would not occur. As a result, a darker dark state is obtained.

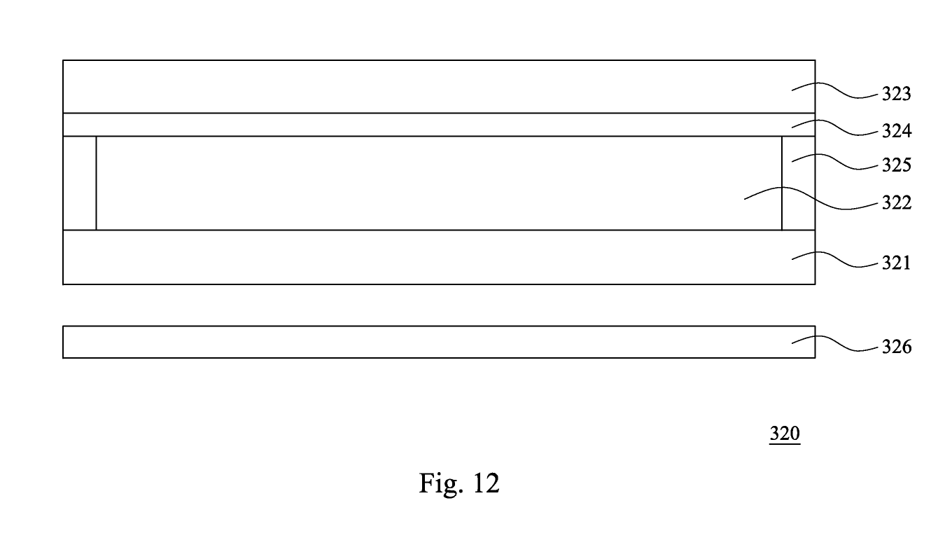

FIG. 12 shows a schematic of a transmissive-type blue phase liquid crystal display according to an embodiment of the present invention. Transmissive-type blue phase liquid crystal display 320 includes first substrate 321, blue phase liquid crystal layer 322, second substrate 323, photo-conversion means 324 sealant 325 and backlight module 326. The elements and function of the present embodiment are similar to that of the previous embodiment of the present invention. Detail illustrations are omitted. However, the photo-conversion means 324 is disposed adjacent to the blue phase liquid crystal layer 322. The photo-conversion means 324 is disposed between the second substrate 323 and the blue phase liquid crystal layer 322.

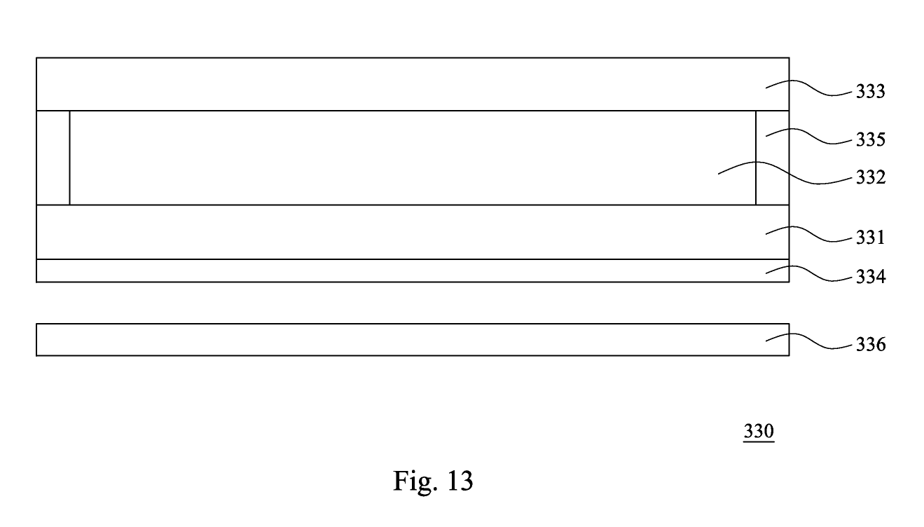

FIG. 13 shows a schematic of a transmissive-type blue phase liquid crystal display according to an embodiment of the present invention. Transmissive-type blue phase liquid crystal display 330 includes first substrate 331, blue phase liquid crystal layer 332, second substrate 333, photo-conversion means 334, sealant 335 and backlight module 336. The elements and function of the present embodiment are similar to that of the above mentioned embodiment of the present invention. Detail illustrations are omitted. The photo-conversion means 334 is located between the first substrate 331 and the backlight module 336.

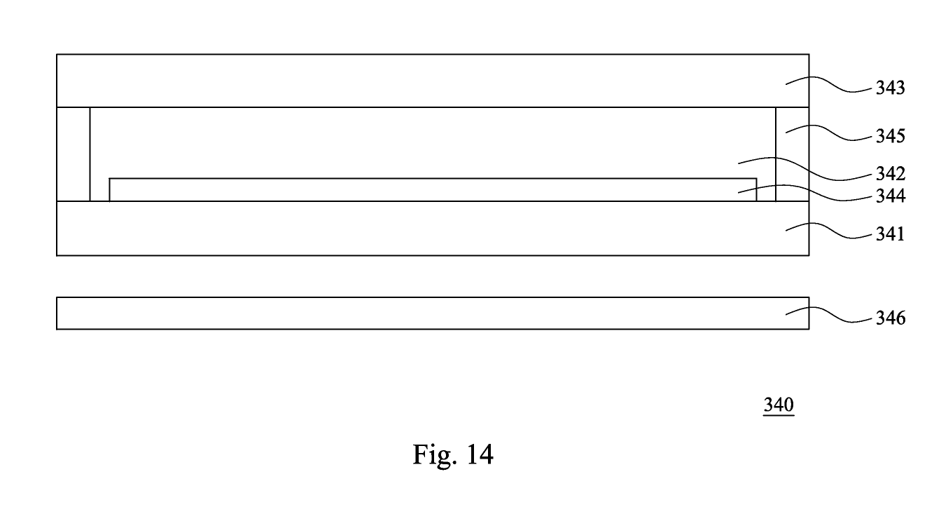

FIG. 14 shows a schematic of a transmissive-type blue phase liquid crystal display according to an embodiment of the present invention. Transmissive-type blue phase liquid crystal display 340 includes first substrate 341, blue phase liquid crystal layer 342, second substrate 343, photo-conversion means 344, sealant 345 and backlight module 346. The elements and function of the present embodiment are similar to that of the above mentioned embodiments of the present invention. Detail illustrations are omitted. The photo-conversion means 344 is disposed adjacent to the blue phase liquid crystal layer 342. The photo-conversion means 344 is disposed between the blue phase liquid crystal layer 342 and the first substrate 341.

It is to be understood that both the foregoing general description and the following detailed description are only examples, and are intended solely to provide further explanation of the invention as claimed.

According to the above mentioned embodiments, in a blue phase liquid crystal display, the photo-conversion means transfers electromagnetic radiation in a one-photon energy transition process or a two-photon energy transition process to a invisible wavelength region so as to decreasing light leakage for generating a darker dark state.

In another embodiment of the present invention, in a cholesteric liquid crystal display, the cholesteric liquid crystal layer comprises chiral nematic liquid crystal molecules. The molecular and optical director (i.e., the unit vector in the direction of average local molecular alignment) of the cholesteric liquid crystal layer rotates in a helical fashion along the dimension (the helical axis) perpendicular to the director. The distance (in a direction perpendicular to the director) that it takes for the director to rotate through a full 360 degree is defined as the pitch of the cholesteric liquid crystal layer.

If the pitch is close to the wavelength of the incident light, a specific rotation light with specific wavelength region will be reflected by the cholesteric liquid crystal layer. Red, green and blue light are reflected by corresponding pixel blocks which contain different chiral dopant-induced structures, and those different structures may generate a color shift of the reflected band.

Images with higher color purity and color gamut ratio can be obtained if the reflected light mentioned above can be controlled to have narrower wavelength regions containing the main peaks in the bright state (planar state).

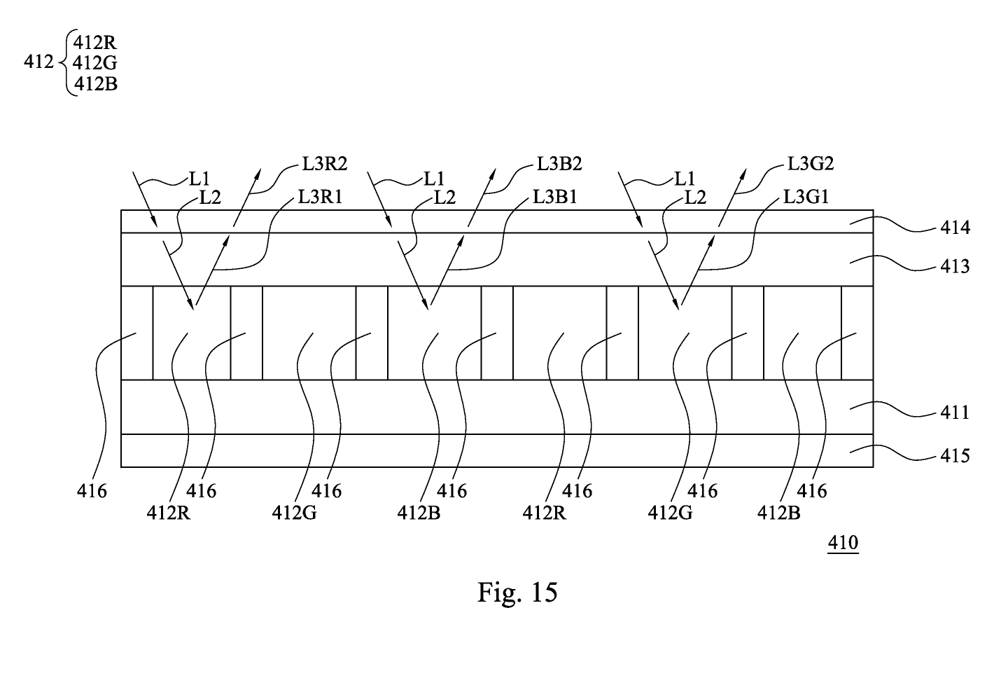

FIG. 15 shows a cholesteric liquid crystal display according to an embodiment of the present invention. Cholesteric liquid crystal display 410 includes first substrate 411, cholesteric liquid crystal layer 412, second substrate 413, photo-conversion means 414, base layer 415 and pixel bank 416. The first substrate 411 may include a pixel array. Pixel array may include scan lines, data lines, thin film transistors and pixel electrodes electrically connected correspondingly. The cholesteric liquid crystal layer 412 may include nematic liquid crystal molecules and chiral dopants. Concentration of the chiral dopants is 0.01% to 10.0% wt %. The second substrate 413 may include a common electrode. Base layer 415 absorbs light and may be black to absorb light which is not reflected by the cholesteric liquid crystal layer 412 in a dark state thereby the contrast ratio can be increased. Bank 416 is disposed between the first substrate 411 and the second substrate 413 to form pixel blocks 412R, 412G and 412B of the cholesteric liquid crystal layer 412 which respectively contain nematic liquid crystal molecules and different chiral dopant structures to generate red, green and blue light.

The structure of the photo-conversion means 414 may be at least one thin film, at least one nano thin film containing quantum dot, wells, or combinations thereof. The material of the photo-conversion means 414 may include an organic material, metal, a semiconductor material or the combinations thereof. The photo-conversion means 414 may be deposited on and contact the second substrate 413, or attached to the second substrate 413, or other suitable manufacturing methods.

As shown in FIG. 15, incident light L1, which may be ambient light or sunlight for example, enters the photo-conversion means 414. For simplicity, only six pixel blocks are shown. Actual structure and numbers of the pixel blocks depend on design needs. The incident light L1 is with a predetermined first electromagnetic radiation region of 200 to 1000 nanometers. The photo-conversion means 414 transfers the incident light L1 into a transferred light L2 passing in the cholesteric liquid crystal layer 412 and reflected by the cholesteric liquid crystal layer 412 to form reflected light L3R1, L3G1 and L3B1 corresponding to red pixel block 412R, green pixel block 412G and blue pixel block 412B. The transferred light L2 is with a predetermined second electromagnetic radiation region which is comprises an exclusive wavelength region of 620 to 660 nanometers, 550 to 590 nanometers and 430 to 470 nanometers. The photo-conversion means 414 further transfers the reflected light L3R1, L3G1 and L3B1 to red image light L3R2, green image light L3G2 and blue image light L3B2, respectively. Red image light L3R2 is with a wavelength region of 620 to 660 nanometers, preferably, of 640 to 660 nanometers. Green image light L3G2 is with a wavelength region of 550 to 590 nanometers, preferably, of 550 to 570 nanometers. Blue image light L3B2 is with a wavelength region of 446 to 486 nanometers, preferably, of 440 to 460 nanometers. Because the corresponding main peak is almost located at the middle of the wavelength region of the image light L3R2, L3G2 or/and L3B2, purer color is obtained to display images with brighter displays and higher color saturations. That is, main peak of the red image light L3R2 is substantially located at the middle of the wavelength region of the red image light L3R2, main peak of the green image light L3G2 is substantially located at the middle of the wavelength region of the green image light L3G2, and main peak of the blue image light L3B2 is substantially located at the middle of the wavelength region of the blue image light L3B2.

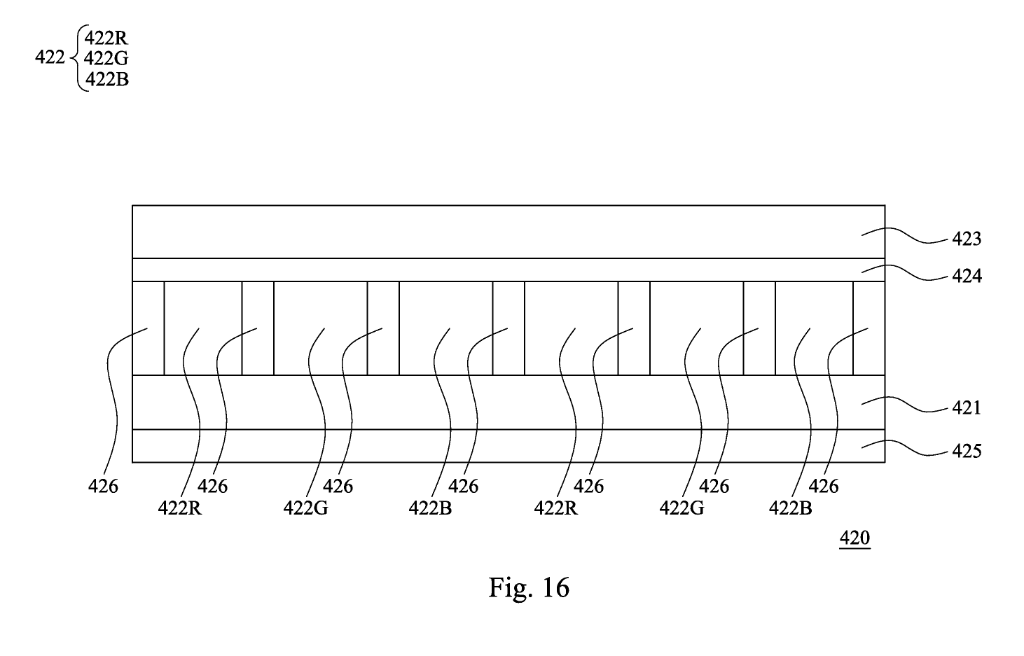

FIG. 16 shows a schematic of a cholesteric liquid crystal display according to an embodiment of the present invention. Cholesteric liquid crystal display 420 includes first substrate 421, cholesteric liquid crystal layer 422, second substrate 423, photo-conversion means 424, base layer 425 and bank 426. Bank 426 is disposed between the first substrate 421 and the second substrate 413 to form pixel blocks 422R, 422G and 422B of the cholesteric liquid crystal layer 422 which respectively contain nematic liquid crystal molecules and different chiral dopant structures to generate red, green and blue light. The elements and function of the present embodiment are similar to that of the previous embodiment of the present invention. Detail illustrations are omitted. However, in the present embodiment, the photo-conversion means 424 is disposed between the second substrate 423 and the cholesteric liquid crystal layer 422.

According to the above mentioned embodiments, in a cholesteric liquid crystal display, the photo-conversion means transfers a light of a predetermined wave length from a predetermined first electromagnetic radiation region to a predetermined second electromagnetic radiation region so as to prevent color shift in bright state.

In the embodiments described above, photo-conversion means transfers an incident light to a transferred light with a specific wavelength region to solve the light leakage or color shift problems of the liquid crystal displays which include helix structures in the liquid crystal layer, such as blue phase liquid crystal layer and cholesteric liquid crystal and the like. In the blue phase liquid crystal layer, light leakage at dark state is generated from the incident light which has wavelength region of 470 to 510 nanometers, and the photo-conversion means of the present embodiments transfer the aforementioned wavelength region to another wavelength region that does not induce the blue phase liquid crystal layer to reflect or diffract unexpected blue light in the dark state. In the blue phase liquid crystal layer, cholesteric liquid crystal layer, the photo-conversion means of the present embodiments transfer the light to have narrower wavelength regions corresponding to purer red, green and blue colors so as to achieve brighter displays and higher color saturations.

The present invention may suitably comprise, consist of, or consist essentially of, any of element, part, or feature of the invention and their equivalents. Further, the present invention illustratively disclosed herein may be practiced in the absence of any element; whether or not specifically disclosed herein. Obviously, numerous modifications and variations of the present invention are possible in light of the above teachings. It is therefore to be understood that within the scope of the appended claims, the invention may be practiced otherwise than as specifically described herein.

1. In a liquid crystal display, a photo-conversion means for transferring a light of a predetermined wave length from a predetermined first electromagnetic radiation region to a predetermined second electromagnetic radiation region.

2. The liquid crystal display of claim 1, wherein said liquid crystal display comprises a blue phase liquid crystal layer.

3. The liquid crystal display of claim 2, wherein said predetermined first electromagnetic radiation region comprises a visible wavelength region, and said predetermined second electromagnetic radiation region comprises an invisible wavelength region.

4. The liquid crystal display of claim 3, wherein said predetermined first electromagnetic radiation region comprises a wavelength region of 470 to 510 nanometers, and said predetermined second electromagnetic radiation region comprises an exclusive wavelength region other than 380 to 680 nanometers.

5. The liquid crystal display of claim 4, wherein said exclusive wavelength region of said predetermined second electromagnetic radiation region is greater than 680 nanometers.

6. The liquid crystal display of claim 4, wherein said exclusive wavelength region of said predetermined second electromagnetic radiation region is smaller than 380 nanometers.

7. The liquid crystal display of claim 3, wherein said blue phase liquid crystal layer includes blue phase liquid crystal molecules and chiral dopants, and the concentration of said chiral dopants is 0.01% to 10.0% wt %.

8. The liquid crystal display of claim 3, wherein a material of said photo-conversion means comprises an organic material, metal, a semiconductor material or the combinations thereof.

9. The liquid crystal display of claim 3, wherein a material of said photo-conversion means comprises 9-Hydroxyphenalen-1-one Ligand.

10. The liquid crystal display of claim 3, having a first substrate, a second substrate, said liquid crystal layer disposed therebetween and a backlight module providing the light of a predetermined wave length, said photo-conversion means being disposed between and the liquid crystal layer and the backlight module.

11. The liquid crystal display of claim 1, wherein said liquid crystal display comprises a cholesteric liquid crystal layer.

12. The liquid crystal display of claim 11, wherein said photo-conversion means transfers a predetermined undesired wavelength of light that is reflected by a cholesteric liquid crystal layer to a predetermined desired wavelength of light.

13. The liquid crystal display of claim 12, wherein said predetermined second electromagnetic radiation region comprises an exclusive wavelength region of 620 to 660 nanometers, 550 to 590 nanometers and 430 to 470 nanometers.

14. The liquid crystal display of claim 11, wherein a material of said photo-conversion means comprises an organic material, metal, a semiconductor material or the combinations thereof.

15. The liquid crystal display of claim 1, having a first substrate, a second substrate and a liquid crystal layer disposed therebetween, said photo-conversion means being disposed between the second substrate and the liquid crystal layer.

16. The liquid crystal display of claim 1, having a first substrate, a second substrate and a liquid crystal layer disposed therebetween, the second substrate being disposed between said photo-conversion means and the liquid crystal layer.

17. The liquid crystal display of claim 1, further comprising a filter layer for blocking said predetermined first electromagnetic radiation region.

18. A blue phase liquid crystal display, having a first substrate, a second substrate and a blue phase liquid crystal layer disposed therebetween, comprising:
a photo-conversion means disposed between said second substrate and said liquid crystal layer, for transferring a light of a predetermined wave length from a predetermined first electromagnetic radiation region to a predetermined second electromagnetic radiation region, said predetermined first electromagnetic radiation region being a visible wavelength region, and said predetermined second electromagnetic radiation region being an invisible wavelength region, thereby decreasing light leakage for generating a darker dark state; wherein said photo-conversion means transfers the wavelength of ambient light before ambient light reflected from the blue phase liquid crystal to the visible region of 470 to 510 nanometers to avoid a shift of the wavelength into the visible region of 470 to 510 nanometers generated by the addition of a chiral dopant.

19. The blue phase liquid crystal display of claim 18, further comprising a thin film transistor array disposed adjacent to said liquid crystal layer, wherein said photo-conversion means is disposed between said thin film transistor array and said second substrate.

20. The blue phase liquid crystal display of claim 18, further comprising a backlight module disposed adjacent to said second substrate, wherein said photo-conversion means is disposed between said backlight module and the second substrate.

21. The blue phase liquid crystal display of claim 18, wherein said predetermined first electromagnetic radiation region comprises a wavelength region of 470 to 510 nanometers, and said predetermined second electromagnetic radiation region comprises an exclusive wavelength region of other than 380 to 680 nanometers.
